(19) United States
(12) Patent Application Publication
(10) Pub. No.: US 2005/0182740 A1
(43) Pub. Date: Aug. 18, 2005

(54) Knowledge asset management system and method

(76) Inventor: Chih-Je Chang, Baihe Township (TW)

Correspondence Address: THOMAS, KAYDEN, HOSTEMEYER & RISLEY LLP, 100 GALLERIA PARKWAY, SUITE 1750, ATLANTA, GA, 30339, US

(21) Appl. No.: 10/778,824

(22) Filed: Feb. 13, 2004

(51) Int. Cl. G06N 5/00; G06N 5/02; G06F 17/00; G06F 19/00

(52) U.S. Cl. 706/50; 700/97

(57) ABSTRACT

A knowledge asset management system and method is provided. In one embodiment, the system includes a database and a processing unit. The database stores a first knowledge asset representation of at least one element, which is a stage or step of a manufacturing process. The processing unit receives at least one analysis target of a process flow, compares the analysis target with the element, and generates manufacturing knowledge including the first knowledge asset representation including domain expertise and manufacturing information for the process flow if the analysis target is the element. The database further stores a second knowledge asset representation of the element, and the processing unit further checks an exception rule, and replaces the first knowledge asset representation with the second knowledge asset representation if the analysis target and the second knowledge asset representation are designated by the exception rule.

### BACKGROUND

The present invention relates to knowledge asset management, and particularly to a knowledge asset management system and method that generate manufacturing knowledge using modular knowledge asset representations.

A knowledge processing system analyzes problems using pre-defined knowledge containing domain expertise and related information of the analysis target. The knowledge is compiled by interviews of field experts, and defined in the knowledge processing system in advance. In product manufacturing, such as semiconductor manufacturing, as the manufacturing technology becomes increasingly complicated, the need for precise and efficient Engineering Data Analysis (EDA) grows, especially for high-end technologies, such as 0.13-micron or even 90-nm processes.

Conventionally, the method of manufacturing knowledge generation is as shown in FIG. 1. First, a process flow of a product is provided (S101). Then, a system manager of the knowledge processing system consults related domain experts and extracts domain expertise regarding the process flow (S102). Finally, the system manager stores the domain expertise in the form of a table, quality function deployment (QFD), factor weighting table, or others in the knowledge processing system (S103).

Since the manufacturing knowledge is closely related to product analysis, when a new product comes to the system, that is a new process flow is required, manufacturing knowledge of the new product must be modified or even re-constructed according to the new process flow. Even more, if the process flow of the new product is totally different from existing procedures, re-interviewing of field experts may be necessary. Obviously, this is costly in terms of human resource assets, and inefficient. Additionally, there may be a large number of new products, causing significant interruption of function in an integrated circuit (IC) foundry, thereby making management of corresponding manufacturing knowledge difficult.

### SUMMARY

The present invention is proposed to address and solve the aforementioned issues.

Accordingly, it is an object of the present invention to provide a knowledge asset management system and method that generates manufacturing knowledge using modular knowledge asset representations.

To achieve the above object, in one exemplary embodiment, the present invention provides a knowledge asset management system and method. The system includes a database and a processing unit. The database stores a first knowledge asset representation of at least one element. The processing unit receives at least one analysis target of a process flow, and generates manufacturing knowledge including the first knowledge asset representation for the process flow if the analysis target matches the element.

The element may be a stage or step of a manufacturing process, and the first knowledge asset representation includes domain expertise and manufacturing information regarding the stage or step.

The database further stores a second knowledge asset representation of the element, and the processing unit further checks an exception rule, and replaces the first knowledge asset representation with the second knowledge asset representation if the analysis target and the second knowledge asset representation are designated by the exception rule.

According to another exemplary embodiment, a method for manufacturing knowledge generation is provided. First, at least one manufacturing process is divided into at least one element, and a first knowledge asset representation of the element is generated. Then, domain expertise and manufacturing information regarding the element are stored in the first knowledge asset representation. Thereafter, at least one analysis target of a process flow is received. The analysis target is then compared with the element, and manufacturing knowledge including the first knowledge asset representation is generated for the process flow if the analysis target matches the element.

The above-mentioned method may take the form of program code embodied in tangible media. When the program code is loaded into and executed by a machine, the machine becomes an apparatus for practicing the invention.

### BRIEF DESCRIPTION OF THE DRAWINGS

The aforementioned objects, features and advantages of this invention will become apparent by referring to the following detailed description of the preferred embodiment with reference to the accompanying drawings, wherein:

FIG. 1 is a flowchart showing the process of a conventional method for manufacturing knowledge generation;

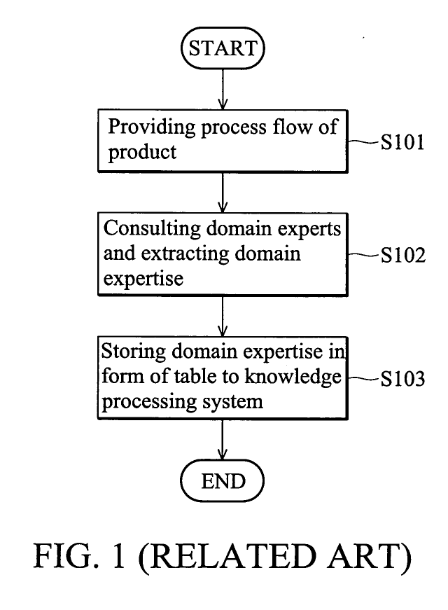

FIG. 2 is a schematic diagram illustrating the architecture of the knowledge asset management system according to an exemplary embodiment of the present invention;

FIG. 3 is a flowchart showing the method for knowledge asset representation generation according to an exemplary embodiment of the present invention;

FIG. 4 is a flowchart showing the method for manufacturing knowledge generation according to one embodiment of the present invention; and

FIG. 5 is a schematic diagram illustrating a storage medium storing a computer program for execution of the knowledge asset management method according to one embodiment of the present invention.

### DESCRIPTION

The present invention provides a system and method for overcoming conventional manufacturing knowledge generation and management problems.

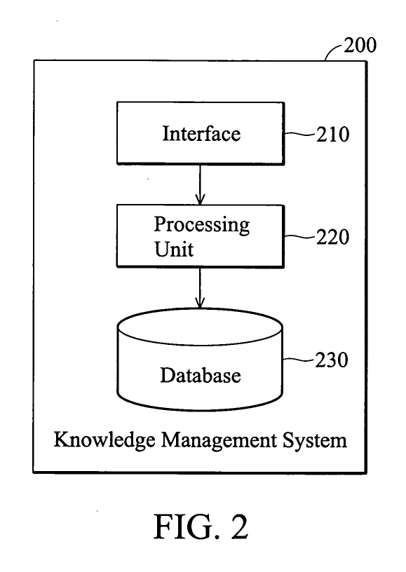

FIG. 2 is a schematic diagram illustrating the architecture of the knowledge asset management system according to one embodiment of the present invention.

The knowledge asset management system 200 comprises an interface 210, a processing unit 220 and a database 230. The interface 210 receives the process flow for a product, and displays manufacturing knowledge generated by the processing unit 220. Each process flow includes analysis targets, such as stages or steps of the process flow. The processing unit 220 performs knowledge generation and management process according to the present invention, and is described in detail below.

The database 230 stores knowledge asset representations corresponding to elements and an exception rule. Each element may be a structural categorized unit, such as stage or step, in which one stage may comprise at least one step in manufacturing process. The knowledge asset representations store domain expertise and manufacturing information regarding respective elements. The exception rule may be in the form of a table and define which element of which product should be replaced by alternative knowledge asset representations.

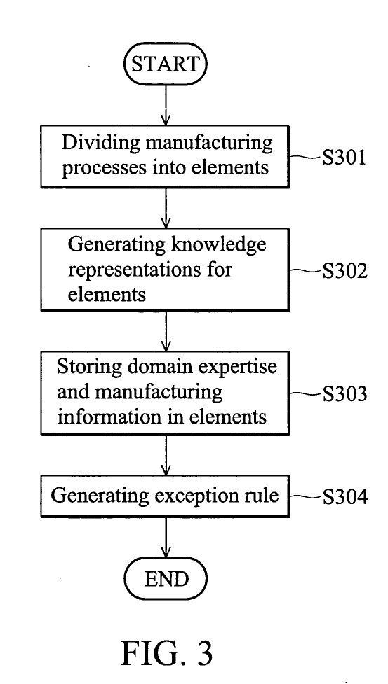

FIG. 3 shows the process of the method for knowledge asset representation generation according to one embodiment of the present invention.

First, in step S301, the manufacturing processes are divided into structurally categorized elements. Then, in step S302, at least one knowledge asset representation is generated for each element. It is understood that several knowledge asset representations may be generated for any one element, and one knowledge asset representation may be defined as default, and the others as alternatives. In step S303, domain expertise and manufacturing information regarding respective elements are stored in the corresponding knowledge asset representations. Then, in step S304, an exception rule is generated. The exception rule defines which element of which product is to be replaced by alternative knowledge asset representations.

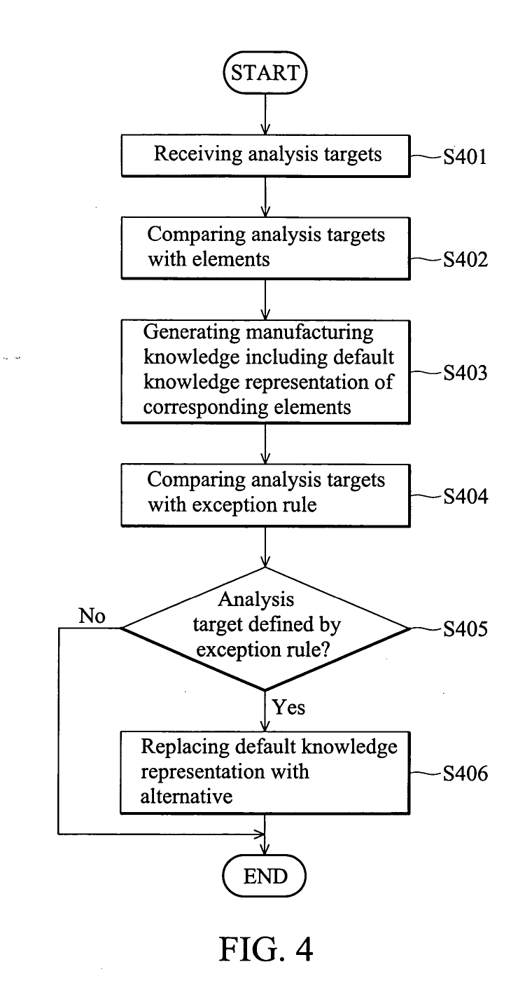

FIG. 4 shows the process of the method for manufacturing knowledge generation according to one embodiment of the present invention.

First, in step S401, a process flow including analysis targets of a product is received. In step S402, each analysis target is then compared with the elements in the database, and in step S403, manufacturing knowledge including default knowledge asset representations of corresponding elements is generated for the process flow if the analysis targets match the elements. Thereafter, in step S404, each analysis target is compared with the exception rule. If the analysis target is not designated by the exception rule (No in step S405), the flow is complete. Otherwise (Yes in step S405), in step S406, the default knowledge asset representation corresponding to the analysis target is replaced by an alternative designated by the exception rule, and the generation procedure is complete. Then manufacturing knowledge is displayed in the interface or stored in the database for further use. It is noted that the analysis target may be compared with the elements and the exception rule simultaneously, such that the replacement of default knowledge asset representation can be omitted.

An example is discussed as follows. The database stores knowledge asset representations in table 1, and exception rule in table 2.

TABLE 1

| | | |
|---|---|---|
| | Default | Alternative |
| | Knowledge asset | Knowledge asset |
| Stage | representation | representation |

| | | | | | |
|---|---|---|---|---|---|
| A | A0 | A1 | A2 | A3 | A4 |
| B | B0 | B1 | B2 | B3 | B4 |
| C | C0 | C1 | C2 | C3 | C4 |
| D | D0 | D1 | D2 | D3 | D4 |
| E | E0 | E1 | E2 | E3 | E4 |

TABLE 2

| | | Alternative |
|---|---|---|
| | | Knowledge asset |
| Product | Stage | representation |
| TM7031 | B | B3 |
| TMH296 | C | C1 |
| TM7712 | X | X2 |

The database stores default knowledge asset representation A0 and alternative knowledge asset representations A1˜A4 for stage A, default knowledge asset representation B0 and alternative knowledge asset representations B1˜B4 for stage B, default knowledge asset representation C0 and alternative knowledge asset representations C1˜C4 for stage C, and default knowledge asset representation D0 and alternative knowledge asset representations D1˜D4 for stage D. The exception rule requires default knowledge asset representation of stage B of product TM7031 to be replaced by alternative knowledge asset representation B3, default knowledge asset representation of stage C of product TMH296 by alternative knowledge asset representation C1, and default knowledge asset representation of stage X of product TM7712 by alternative knowledge asset representation X2.

If a process flow having stage A, B and C of a product TM7031 is received by the system, the processing unit compares the analysis target (stage) A, B and C to Table 1 and Table 2, generates manufacturing knowledge by collecting the knowledge asset representations A0, B3 and C0, and displays the manufacturing knowledge in the interface or stores it in the database.

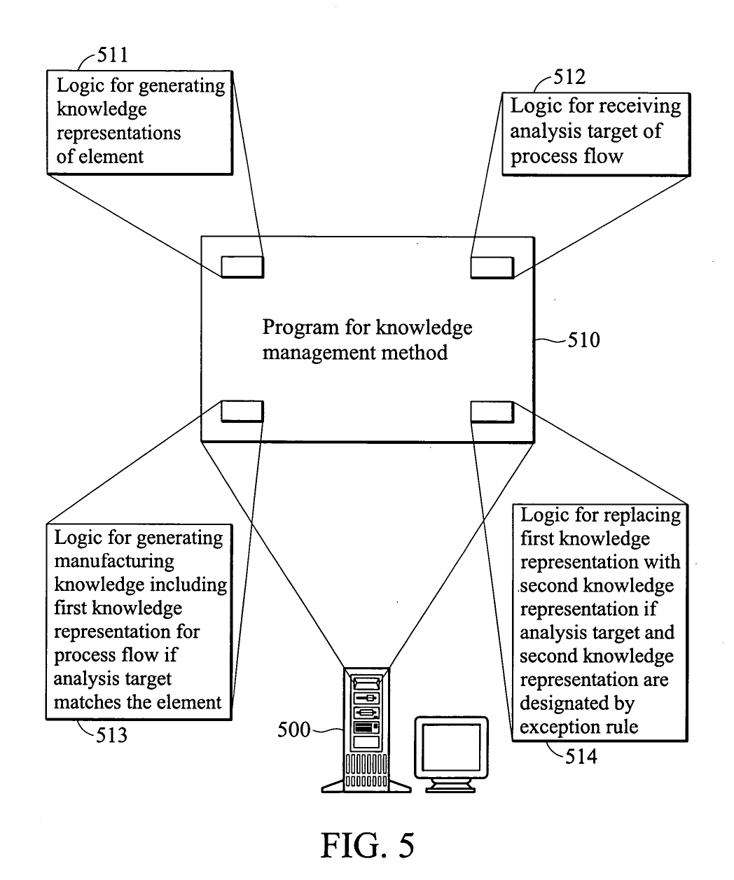

FIG. 5 is a diagram of a storage medium storing a computer program providing the knowledge asset management method according to one embodiment of the present invention. The computer program product includes a storage medium 510 having computer readable program code embodied in the medium for use in a computer system 500, the computer readable program code comprises at least computer readable program code 511 generating knowledge asset representations of at least one element, computer readable program code 512 receiving at least one analysis target of a process flow, computer readable program code 513 generating manufacturing knowledge including a first knowledge asset representation for the process flow if the analysis target matches the element, and computer readable program code 514 replacing the first knowledge asset representation with a second knowledge asset representation if the analysis target and the second knowledge asset representation are designated by an exception rule.

The present invention thus provides a knowledge asset management system and method that generates manufacturing knowledge using modular knowledge asset representations. If new products enter the system, only the part of knowledge asset representations corresponding to differences in the stages need be modified or constructed accordingly, thereby improving the efficiency of manufacturing knowledge generation, and making knowledge asset management easier.

The method and system of the present invention, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The method and systems of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to application specific logic circuits.

Although the present invention has been described in its preferred embodiments, it is not intended to limit the invention to the precise embodiments disclosed herein. Those skilled in this technology can still make various alterations and modifications without departing from the scope and spirit of this invention. Therefore, the scope of the present invention shall be defined and protected by the following claims and their equivalents.

1. A knowledge asset management system, comprising:
a database storing a first knowledge asset representation of at least one element; and
a processing unit receiving at least one analysis target of a process flow, and generating manufacturing knowledge including the first knowledge asset representation for the process flow if the analysis target matches the element.

2. The system of claim 1 wherein the database further stores a second knowledge asset representation of the element, and the processing unit further checks an exception rule, and replaces the first knowledge asset representation with the second knowledge asset representation if the analysis target and the second knowledge asset representation are designated by the exception rule.

3. The system of claim 1 wherein the element is a stage of a manufacturing process.

4. The system of claim 1 wherein the element is a step of a manufacturing process.

5. The system of claim 3 wherein the first knowledge asset representation comprises domain expertise and manufacturing information regarding the stage.

6. The system of claim 4 wherein the first knowledge asset representation comprises domain expertise and manufacturing information regarding the step.

7. The system of claim 1 further comprising an interface to receive the process flow and display the manufacturing knowledge, or a database to store the generated manufacturing knowledge.

8. A knowledge asset management method, comprising the steps of:
providing a first knowledge asset representation of at least one element;
receiving at least one analysis target of a process flow;
and
generating manufacturing knowledge including the first knowledge asset representation for the process flow if the analysis target matches the element.

9. The method of claim 8 further comprising the steps of:
providing a second knowledge asset representation of the element;
checking an exception rule; and
replacing the first knowledge asset representation with the second knowledge asset representation if the analysis target and the second knowledge asset representation are designated by the exception rule.

10. The method of claim 8 wherein the element is a stage of a manufacturing process.

11. The method of claim 8 wherein the element is a step of a manufacturing process.

12. The method of claim 10 wherein the first knowledge asset representation comprises domain expertise and manufacturing information regarding the stage.

13. The method of claim 11 wherein the first knowledge asset representation comprises domain expertise and manufacturing information regarding the step.

14. The method of claim 8 further comprising receiving the process flow and displaying the manufacturing knowledge via an interface, or to store the manufacturing knowledge to a database.

15. A machine-readable storage medium storing a computer program which, when executed, causes a computer to perform a knowledge asset management method, the method comprising the steps of:
providing a first knowledge asset representation of at least one element;
receiving at least one analysis target of a process flow; and
generating manufacturing knowledge including the first knowledge asset representation for the process flow if the analysis target matches the element.

16. The storage medium of claim 15 wherein the method further comprises the steps of:
providing a second knowledge asset representation of the element;
checking an exception rule; and
replacing the first knowledge asset representation with the second knowledge asset representation if the analysis target and the second knowledge asset representation are designated by the exception rule.

17. The storage medium of claim 15 wherein the element is a stage of a manufacturing process.

18. The storage medium of claim 15 wherein the element is a step of a manufacturing process.

19. The storage medium of claim 17 wherein the first knowledge asset representation comprises domain expertise and manufacturing information regarding the stage.

20. The storage medium of claim 18 wherein the first knowledge asset representation comprises domain expertise and manufacturing information regarding the step.

21. The storage medium of claim 15 wherein the method further comprises receiving the process flow and displaying the manufacturing knowledge via an interface or store the manufacturing knowledge in the storage medium.

22. A method for manufacturing knowledge generation, comprising the steps of:
dividing a manufacturing process into at least one element;
generating a first knowledge asset representation of the element;
receiving at least one analysis target of a process flow; and
generating manufacturing knowledge including the first knowledge asset representation for the process flow if the analysis target matches the element.

23. The method of claim 22 further comprising the steps of:
generating a second knowledge asset representation of the element;
checking an exception rule; and
replacing the first knowledge asset representation with the second knowledge asset representation if the analysis target and the second knowledge asset representation are designated by the exception rule.

24. The method of claim 22 wherein the element is a stage of the manufacturing process.

25. The method of claim 22 wherein the element is a step of the manufacturing process.

26. The method of claim 22 further comprising storing domain expertise and manufacturing information of the element in the first knowledge asset representation.

27. The method of claim 22 further comprising receiving the process flow and displaying the manufacturing knowledge via an interface or store the manufacturing knowledge in a database.
